(19) United States
(12) Patent Application Publication
(10) Pub. No.: US 2023/0214403 A1
(43) Pub. Date: Jul. 6, 2023

(54) Method and System for Segmenting Unstructured Data Sources for Analysis

(71) Applicant: Breakwater Solutions LLC, Austin, TX (US)

(72) Inventors: Amir Jaibaji, Austin, TX (US); Markus Lorch, Dettenhausen (DE); Philip Richards, Pleasant Grove, UT (US); Lucija Sosic, Zagreb (HR); Mateo Premus, Rijeka (HR)

(73) Assignee: Breakwater Solutions LLC, Austin, TX (US)

(21) Appl. No.: 17/565,621

(22) Filed: Dec. 30, 2021

(51) Int. Cl. G06F 16/25; G06F 17/18

(52) U.S. Cl. CPC G06F 16/254; G06F 17/18

(57) ABSTRACT

Described are computer-implementable method, system and computer-readable storage medium for segmenting data and information of unstructured data sources. The data and information can be documents and files. Connecting is performed to one or more unstructured data sources that store the data and information. Metadata is extracted from the data and information. A probability using one or more algorithms, as to existence of defined indicators of the data and information is performed. Segmentation is performed based on the calculated probability of indicator. Assessing of data and information is performed to confirm the indicators. Training of algorithms if determined is performed.

### BACKGROUND OF THE INVENTION

### Field of the Invention

The present invention relates to computer implemented processing and analysis of data and information. More specifically, embodiments of the invention provide for the segmenting of data and information of unstructured data sources.

### Description of the Related Art

As the value and use of information continues to increase, individuals and businesses seek additional ways to process and store information and data. The size of information and data to be processed can be daunting, reaching seemingly unmanageable sizes. Many businesses and enterprises deal with petabytes of information and data. To scan and index such large amounts of information and data can take up significant time and resources.

Data and information should be protected from breaches in security. Good business practice dictates and can require data and information to meet privacy regulations. Customer and employee personal data and information are identified, protected, and sometimes removed. Furthermore, certain high value data and information that includes business data, regulatory records, etc. may need to be identified. Enterprises often are faced with multi-year projects that deal with processing data and information that can lead to high infrastructure costs and high overhead processes.

### SUMMARY OF THE INVENTION

A computer-implementable method, system and computer-readable storage medium for segmenting data and information of unstructured data sources comprising: connecting to one or more unstructured data sources; extracting metadata of data and information of the unstructured data sources; calculating probability using one or more algorithms to determine existence of indicators of the data and information; segmenting of the data and information based on the calculated probability of indicators; assessing of data and information to confirm the indicators; and determining if algorithm training is to be performed.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a system for segmenting of data and information of unstructured data sources as implemented in the present invention;

FIG. 3 illustrates a general illustration of a components for machine learning computing resource for segmenting of data and information of unstructured data sources as implemented in the present invention; and

FIG. 4 is a generalized flowchart for segmenting of data and information of unstructured data sources as implemented in the present invention.

### DETAILED DESCRIPTION

Various implementations provide segmentation of data and information, such as documents in data sources. In particular, identifying areas that may contain high risk or high value data and information (e.g., documents and files). Scanning and indexing can be performed on the identified/segmented data and information (e.g., documents and files) to produce tangible results.

Implementations further can provide for continued scanning and indexing of identified lower risk or lower value data and information (e.g., documents and files). The process can be performed until an entire data set is covered.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for personal, business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

It is to be understood, that in various embodiments, other computing systems can perform the described data preparation, algorithms, processes, steps, etc., and is not limited to an information handling system, which is used as an example herein. Other computing systems can include cloud computing systems, virtual machine(s), container(s), physical hardware, function, logic application, or any other computation system.

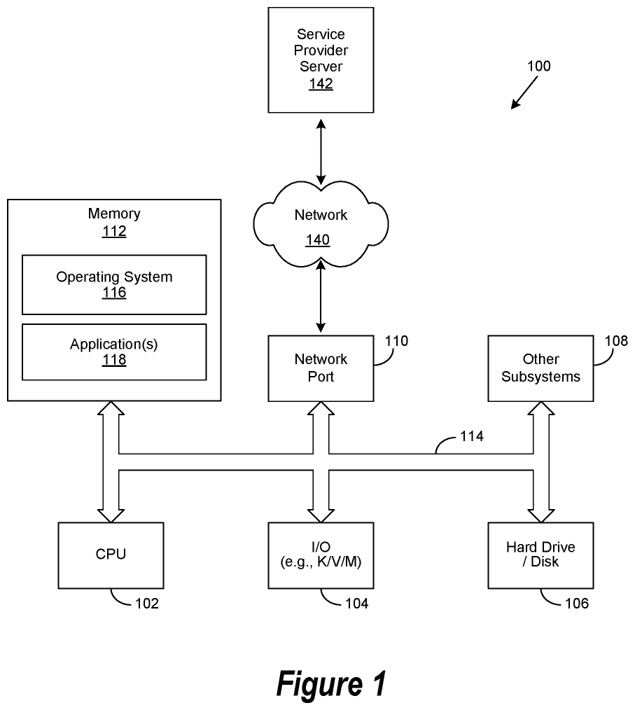

FIG. 1 is a generalized illustration of an information handling system 100 that can be used to implement the system and method of the present invention. Information handling system 100 is an example embodiment of a computing system that can implement the described methods and processes herein. The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108.

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more buses 114. System memory 112 can be implemented as hardware, firmware, software, or a combination of such. System memory 112 further includes an operating system (OS) 116. Embodiments provide for the system memory 112 to include applications 118. In certain implementations, the information handling system 100 may access use of the applications 118 from an external source, such as a website (e.g., online or remote applications). In various embodiments, applications 118 provide and perform the processes and methods described herein. As discussed, other computation systems may be implemented. Applications 118 or similar functionality may reside upon such other computational systems.

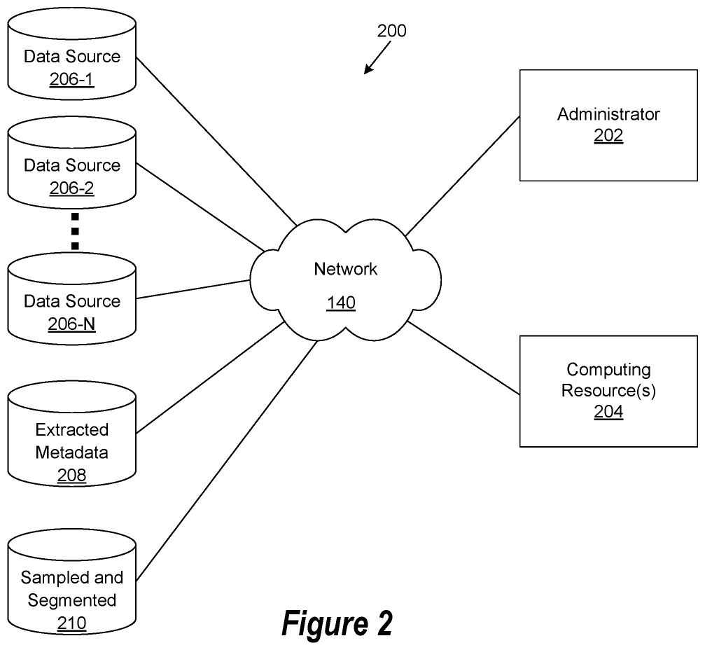

FIG. 2 shows a system for segmenting of data and information (e.g., documents and files) of unstructured data sources. Implementations provide for system 200 to include an administrator 202, which represents computation systems, such as one or more information handling systems 100, accessible by users that desire to process and analyze data and information. Users can be a person, business or other enterprise.

Implementations further can provide for computing resource(s) 204 that perform to the processes and methods described herein. As discussed, computing resource(s) 204 can include one or more information handling systems 100, cloud computing systems, virtual machine(s), container(s), physical hardware, function, logic application, or any other computation system. In certain embodiments, computing resource(s) 204 are included as part of administrator 202.

Embodiments provide for administrator 202 to connect with computing resource(s) 204 via the described network 140. Implementations further provide for the system 200 to include and the network 140 to connect to the one or more data sources 206-1, 206-2 to 206-N. The network 140 includes any network, internet, virtual network or any other connection available for the data sources 206.

Data sources 206 may be physical, virtual, etc. locations where unstructured data and information is placed by a user, system, corporation, enterprise, and/or other entity. Examples of data sources 206 can include file systems, hard drives, cloud data stores, disk drives, file servers, network attached storage (NAS) devices, storage area network (SAN) devices, block storage devices, mobile devices, redundant array of independent disks (RAID) systems, data lakes, or other storage systems. Data sources 206 can include unstructured data and information, such as documents and/or files.

Implementations provide for metadata extraction from unstructured data and information, such as documents and/or files of the data sources 206. The extracted metadata is related to the document or file from which the metadata is extracted. Document or file metadata can be defined as information as to unstructured data and information of a data source 206.

Metadata can be related to one or more documents or files in an unstructured data set. The metadata can be any information related to the document or file, and can vary from different data sources 206. Metadata may include information such as file name, file path, file type, size, owner, last modified by, create date, last modified date, modification history, access permissions, groups, tags, categories, logical locations, physical locations, geographic locations, identifiers, or any other information that may be generated by a system.

Implementations provide for generation of metadata to be performed by computing resource(s) 204. Computing resource(s) 204 accesses the data sources 206 and can perform generation or extraction of metadata. Metadata extraction is further described herein. Embodiments provide for extracted metadata to be stored in a location(s) represented by extracted metadata 208, which can be a file system, database or other data structure.

Implementations further provide for the system 200 to include sampled and segmented documents and files 210. Sampling and segmentation are further described herein. As discussed, data and information of high risk or high value are identified and segmented, and if desired identifying and segmented lower risk or lower value data and information. As described herein, machine learning models may be used on the extracted metadata 208, which can be created for a given data set.

Implementations provide for sampling and assessment. As described herein, indicators can be defined by a user such as administrator 202, where indicators are used to select algorithms descried herein.

Indicators can be defined as data, text, metadata, or other information of interest in a document or file. Indicators can represent concepts or be discrete data elements. For example, indicators can be related to Personally Identifiable Information (PII) such as social security numbers, names, addresses, account numbers, or other related items. Indicators can be related to any type of information of interest, for example client data, employee data, intellectual property, health information, unannounced products, risk information, or any other information that an individual, corporation or entity may want to identify. Indicators could be any type of information, including text, numbers, metadata, drawings, diagrams, formatting, pictures, audio, video, multimedia, binary data, or any other type of information that exists in a document or file.

As discussed, indicators can be defined by a user administrator 202. The defining of indicators can be through the use of methods such searches, regular expressions, natural language processing, entity extraction, data matching, data mining, machine learning or any other method for specifying an indicator.

Document or file assessment provides for confirming existence or absence of the indicator in a document or file. In addition to the described metadata, assessment can use other information, such as full text analysis, indexing, machine learning, human review, or any other data available. In certain implementations, assessment process can perform file expansion, such as extracting files from a file archive, emails from a mail archive, or files embedded in documents, etc. Implementations also provide for assessment to perform optical character recognition (OCR), entity extraction, clustering, n-gram singling, deduplication, near-duplicate detection, or any other method to generate information about a document or file.

Algorithms can be used to calculate probability of the existence of indicators. Algorithms can be defined as a method to determine the probability of the existence of one or more indicators in a document. Algorithms may include heuristics, statistics, searches, expressions, classifiers, machine learning algorithms (supervised or unsupervised), natural language processing, or any other algorithm that can use input data to provide a probability output. The probability output may range from zero (meaning no probability of the existence of an indicator) to one (indicating the certainty of the existence of an indicator). These algorithms may be generic to be applied to all data sources or may be specific to a data source. Each algorithm may be trained or updated, where it is modified based on training data, feedback loops, or human judgement.

As further described herein sampling and assessment can be used to confirm results of calculation of a probability of existence of indicators, or to use results to train, re-train, or generate new algorithms for calculating the probability of indicators. Sampling can be a full random sampling, can be stratified based on the segment or any other metadata, can be administrator 202 selection of documents or files, or can be a complete selection of every document and file. Each document or file selected in sampling step can be assessed to confirm or deny the existence of an indicator, as defined by an indicator definition.

In an example scenario, connection is made to a data source 206, such as a network attached storage file system. Access is given to the documents and files stored on the network attached storage file system if appropriate credentials are given to administrator 202 and the metadata can be extracted related to those files. If the desire is to find personally identifiable information (PII), an algorithm or model can be available or exist that allows for a high probability of finding PII for example in Microsoft® Word documents. For example, Microsoft® Word documents that include titles words such as HR (human resources), employee, customer. A segment of documents and files with high probability of including PII, can be found on the network attached storage file system data source 206.

Implementations can provide for an additional step or process that improves the algorithm or model. A statistical sample can be performed on the documents and files of any data source 206. For example, evaluation is performed as to PII to determine attributes of documents and files that contain PII for a particular installation. Based on the sample, a new algorithm or model that tells us that the majority of Excel files created in 2005-2008 in a folder called HR are extremely likely to have PII. Therefore, documents and files (i.e., data) can be segmented to prioritize search for interesting (i.e., high risk or high value) documents and files (i.e., data).

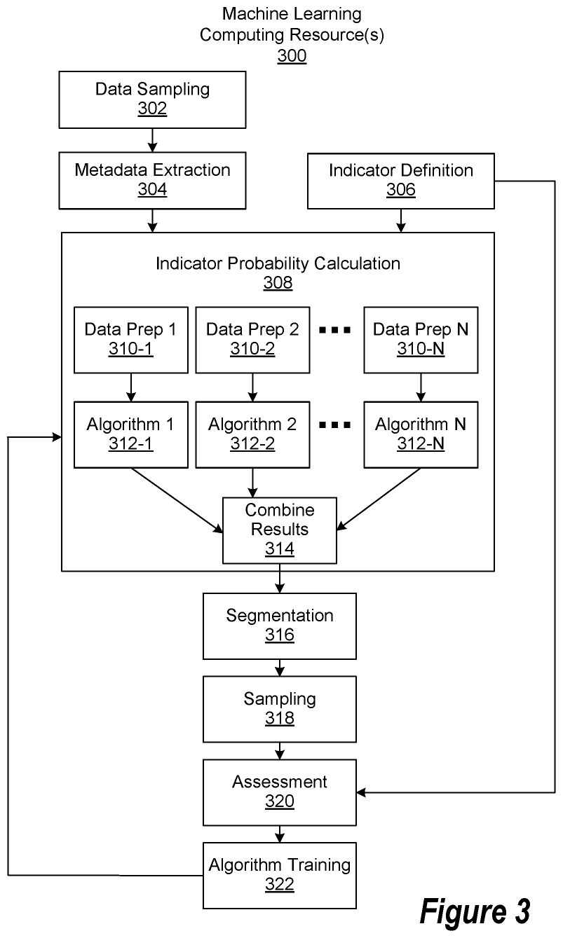

FIG. 3 shows a block diagram of a machine learning computing resource(s) 300 for segmenting of data and information of unstructured data sources. The machine learning computing resource(s) 300 can be included in computing resource(s) 204.

The machine learning computing resource(s) 300 can be implemented as information handling system 100, or other computing systems such as cloud computing systems, virtual machine(s), container(s), physical hardware, function, logic application, etc. In particular, applications 118 described in FIG. 1, or similar functional may reside upon such other such other computational systems.

As discussed, metadata extraction is performed on documents and files (i.e., data) of data sources 206. Connection is performed with computing resource(s) 204, and particularly machine learning computing resource(s) 300 to data sources 206. Implementations provide for the machine learning computing resource(s) 300 to include data sampling 302, a metadata extraction component 304 that connects to data sources 206 to retrieve, generate, query or otherwise obtain metadata related to the unstructured documents and files (i.e., data) of data sources 206. Connection can include authentication information required to access the data source 206, and performed using network 140.

Implementations provide for metadata extraction to operate on a single or multiple data sources 206, simultaneously or in serial order.

The machine learning computing resource(s) 300 can include indicator definition 306 which may be defined by users or administrator 202. Indicators are defined above, and are identified using select algorithms or methods.

An indicator probability calculation component 308 receives indicators from indication definition 306 and metadata from metadata extraction 304. The indicator probability calculation component 306 includes one or more data preparation components data prep 1 310-1, data prep 2 310-2 to data prep N 310-N.

Data preparation involves the following. For each method or algorithm, distinct data preparation may be needed, which can include formatting, converting, transforming, cleaning, clipping, grouping, normalizing, partitioning, adding, removing, math operating, selecting, splitting or other data operations. Data preparation can also include text analytics such as converting word to vector, extracting n-gram features, feature hashing, lemmatization, or other text operations.

The indicator probability calculation component 306 includes one or more method or algorithm components, algorithm 1 312-1, algorithm 2 312-2 to algorithm N 312-N. Each of the algorithms 312 uses extracted metadata from metadata extraction 302 to determine the probability of existence of one or more indicators. Implementations provide for metadata to be prepared or modified by data prep 310, before input to an algorithm 310. One or more algorithms 312 can operate on the documents and files (i.e., data), with no limit as to the number of algorithms 312 that can be applied.

Implementations provide for results of each algorithm 312 to be combined in component identified as combined results 314. The combined results is an overall probability for each indicator for each document or file (i.e., data). The indicator probability calculation component 308 can run multiple times for each set of metadata, with either the same or different algorithms 312 each time.

Implementations provide for data prep 310 and algorithms 312 to operate on a single or multiple sets of metadata either simultaneously or in serial order. The individual or multiple results can be stored in a file system or database or any other data structure. The results are related to the document or file (i.e., data) for which the results were calculated.

Various implementations provide for the machine learning computing resource(s) 300 to results from the combined algorithms 312 to assign documents or files or sets of documents or files to segmentation component 316. Segments are generated by distributing the documents and files based on their probability scores. Segments can exist based on each individual indicator or may be a combined results of multiple or all indicators. Each document or file will exist in at least one segment but may exist in multiple segments across indicators or groups of indicators. Segments, based on single indicators or groups of indicators, can be pre-defined, dynamic, or user (administrator 202) defined.

Segments provide the ability to group documents and files by probability scores. Implementations provide for segments to be available for use by other systems to perform operations on the segments. Segments can be used by any outside system or user for actions, reporting or any other activity. The segments can be stored in a file system or database or any other data structure. The results are related to the document or file (i.e., data) for which the results were calculated.

Various implementations provide for the machine learning computing resource(s) 300 to provide for sampling 318 and assessment 320 to confirm the results of the calculation of probability of existence of indicators, or to use the results to train, re-train or generate new algorithms for calculating the probability of existence of indicators. The sampling 318 can be full random sampling, can be stratified based on the segment or any other metadata, can be a user selection of document and files, or can be a complete selection of every document or file.

Each document or file that is selected in the sampling 318 can be assessed by assessment 320 to confirm or deny the existence of an indicator, as defined in the indicator definition 306. The assessment 320 can use additional information as to the metadata from metadata extraction 304 that is used in the calculation of probability of existence of indicators. In certain implementations, assessment 320 can be complemented by user or administrator 202 review of the documents and files. The results of sampling 318 and assessment 320 can be stored in a file system or database or any other data structure. The results are related to the document or file (i.e., data) for which the results were calculated.

Implementations provide for the machine learning computing resource(s) 300 to include algorithm training 322 as part of machine learning. The results of the assessment 320 provide information about confirmed existence or absence of indicators in a document or file, and can be used to train or re-train algorithms as represented by algorithm training 322. Each data prep 310 and algorithms 312 used in the calculation of the probability of the existence of indicators may or may not be re-trained. Data prep 310 and algorithms 312 can be added or removed in algorithm training 322. The component combining results 314 can also be updated based on algorithm training 320 (i.e., the training, re-training or adding of algorithms or methods). It is to be understood that there is no limit as to the number of times an algorithm 312 can be retrained, and no limit as to the frequency of retraining.

In certain implementations, algorithm training 322 can be complemented by user or administrator 202 judgement in updating of models or algorithms. The results of the training and data generation algorithm and combining steps will be stored in a file system or database or any other data structure.

Implementations provide for the machine learning computing resource(s) 300 to run or multiple times on a document or file, or a set of documents or files. Results of each run of machine learning computing resource(s) 300 can be stored and made available for use by other system. Each process performed by the components can record report and logging information each time the component performs runs, and can be used for analysis, reporting or display.

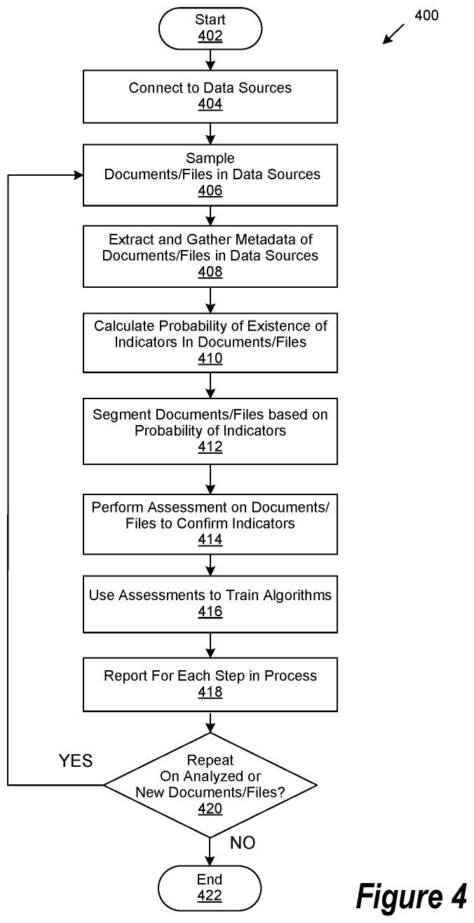

FIG. 4 is a generalized flowchart for segmenting data and information of unstructured data sources, where data and information includes documents and files. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention. Implementations provide for the process 400 to be performed by an information handling system 100 as described in FIG. 1, or other computing systems that include cloud computing systems, virtual machine(s), container(s), physical hardware, function, logic application, or any other computation system.

At step 402, the process 400 starts. At step 404, connecting is to data sources is performed, such as computing resource(s) 204 and machine learning computing resource(s) 300 to data sources 206 as described herein.

At step 406, sampling is performed as to documents and files of the data sources. At step 408, extraction and gathering of metadata of data and information, such as documents and files in data sources is performed. The machine leaning computing resource(s) 300 includes the metadata extraction component 304 that can perform this step.

At step 410, calculating the probability of the existence of indicators in documents and files is performed. The indicator probability calculation component 306 of the machine leaning computing resource(s) 300 can perform this step.

At step 412, segmenting of documents and files based on the probability of indicators is performed. The segmentation 316 of the machine leaning computing resource(s) 300 can perform this step.

At step 414, assessing of documents and files to confirm the indicators is performed. The assessment 320 of the machine leaning computing resource(s) 300 can perform this step.

At 416, assessments are used to train the algorithms. The algorithm training 322 of the machine leaning computing resource(s) 300 can perform this step

At step 418, reporting can be performed for results for each of the steps of process 400. If it is determined that a repeat on analyzed documents or files, or new documents or files, is desired, then following the YES branch step 420, step 408 is performed. Otherwise, following the NO branch of step 420, at step 422 the process ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, low-code, no-code etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for segmenting data and information of unstructured data sources comprising:
connecting to one or more unstructured data sources;
extracting metadata of data and information of the unstructured data sources;
calculating probability using one or more algorithms to determine existence of indicators of the data and information;
segmenting of the data and information based on the calculated probability of indicators;
assessing of data and information to confirm the indicators; and
determining if algorithm training is to be performed.

2. The computer-implementable method of claim 1, wherein the data and information includes documents and files.

3. The computer-implementable method of claim 1, wherein the calculating probability using algorithms includes uses extracted metadata in determining probability of existence of one or more indicators.

4. The computer-implementable method of claim 1, wherein indicators are defined and are used to select the one or more algorithms.

5. The computer-implementable method of claim 1, wherein indicators are used in the assessing.

6. The computer-implementable method of claim 1, wherein data preparation is performed for each of the one or more algorithms.

7. The computer-implementable method of claim 1 further comprising combining results of the one or more algorithms.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for segmenting data and information of unstructured data sources and comprising instructions executable by the processor and configured for:
connecting to one or more unstructured data sources;
extracting metadata of data and information of the unstructured data sources;
calculating probability using one or more algorithms to determine existence of indicators of the data and information;
segmenting of the data and information based on the calculated probability of indicators;
assessing of data and information to confirm the indicators; and
determining if algorithm training is to be performed.

9. The system of claim 8, wherein the data and information includes documents and files.

10. The system of claim 8, wherein the calculating probability using algorithms includes uses extracted metadata in determining probability of existence of one or more indicators.

11. The system of claim 8, wherein indicators are defined and are used to select the one or more algorithms.

12. The system of claim 8, wherein indicators are used in the assessing.

13. The system of claim 8, wherein data preparation is performed for each of the one or more algorithms.

14. The system of claim 8 further comprising combining results of the one or more algorithms.

15. A non-transitory, computer-readable storage medium embodying computer program code, the computer program code comprising computer executable instructions configured for:
connecting to one or more unstructured data sources;
extracting metadata of data and information of the unstructured data sources;
calculating probability using one or more algorithms to determine existence of indicators of the data and information;
segmenting of the data and information based on the calculated probability of indicators;
assessing of data and information to confirm the indicators; and
determining if algorithm training is to be performed.

16. The non-transitory, computer-readable storage medium of claim 15, wherein the calculating probability using algorithms includes uses extracted metadata in determining probability of existence of one or more indicators.

17. The non-transitory, computer-readable storage medium of claim 15, wherein indicators are defined and are used to select the one or more algorithms.

18. The non-transitory, computer-readable storage medium of claim 15, wherein indicators are used in the assessing.

19. The non-transitory, computer-readable storage medium of claim 15, wherein data preparation is performed for each of the one or more algorithms.

20. The non-transitory, computer-readable storage medium of claim 15 further comprising combining results of the one or more algorithms.
